(19) United States
(12) Patent Application Publication
(10) Pub. No.: US 2011/0314643 A1
(43) Pub. Date: Dec. 29, 2011

(54) MAGNETIC CLIP

(76) Inventor: Te-Ming Huang, Taipei County (TW)

(21) Appl. No.: 12/822,299

(22) Filed: Jun. 24, 2010

(51) Int. Cl. F16B 2/20; H01F 7/00

(52) U.S. Cl. 24/303

(57) ABSTRACT

A magnetic clip is provided. The magnetic clip includes a first plate and a second plate. The first plate includes a first surface and a second surface. The second plate includes a first surface and a second surface. The first plate and the second plate are oppositely arranged, such that the first surface of the first plate and the first surface of the second plate are oppositely positioned. At least one magnet is provided at the first surface of the first plate. At least one metal ball is provided at the second plate correspondingly to the magnet. When the magnet approaches to the metal ball, the metal ball is magnetized, and becomes another ball-shaped magnet. Therefore, small metal objects such as a key ring, paper clips, or drawing pins can be directly put on the metal ball without opening the first plate 1 and the second plate.

### BACKGROUND OF THE INVENTION

1. Field of the Invention

The present invention relates generally to a clip member adapted for clamping a note paper or magnetically holding a small metal object.

2. The Prior Arts

Note paper clips are small stationeries that often are put on desks or tables, or disposed on walls. A typical note paper clip is usually used for clamping a note paper or magnetically holding a small metal object.

Generally, there are several kinds of note paper clips as follows. A first kind conventional note paper clip includes two clip members, and a spring member disposed between the clip members. The spring member provides an elastic force against the two clip members so as to apply a clipping force on a note paper. A second kind conventional note paper clip includes a body and an oblique plate. The body includes a steel ball. The steel ball is driven by the gravity against the oblique plate. When a note paper is inserted between the steel ball and the oblique plate, the steel ball and het oblique plate cooperatively apply a friction against the note paper, thus holding the note paper thereby. A third kind conventional note paper clip includes a socket configured with a paperclip like holding unit. The note paper can be inserted in the holding unit and is then held thereby. A fourth kind of conventional note paper clip includes a socket having two magnets disposed at two opposite sides of the socket. The note paper can then be held by a magnetic force applied by the two magnets.

### SUMMARY OF THE INVENTION

Accordingly, a primary objective of the present invention is to provide a magnetic clip for clamping a note paper or magnetically holding a small metal object without facilitation of spring member or gravity.

The present invention provides a magnetic clip. The magnetic clip includes a first plate and a second plate. The first plate includes a first surface and a second surface. The second plate includes a first surface and a second surface. The first plate and the second plate are oppositely arranged, such that the first surface of the first plate and the first surface of the second plate are oppositely positioned. At least one magnet is provided at the first surface of the first plate. At least one metal ball is provided at the second plate correspondingly to the magnet.

According to an aspect of the embodiment, the first plate includes a first pair of protrusion ears protruded from the first surface of the first plate. The first pair of protrusion ears are integrally formed together with the first plate. The second plate includes a second pair of protrusion ears protruded from the first surface of the second plate. The second pair of protrusion ears are integrally formed together with the second plate. The first pair of protrusion ears are configured with axially corresponded pivotal holes respectively, and the second pair of protrusion ears are configured with axially corresponded pivotal shafts respectively. The pivotal holes and the pivotal shafts are adapted to match each other, such that the first plate and the second plate can be pivotally coupled thereby. In such a way, the first plate and the second plate are allowed to swing relative to each other.

According to another aspect of the embodiment, the first plate is configured with a first through hole, and the second plate is configured with a second through hoe. The magnet is assembled to the first through hole of the first plate, such that two ends of the magnet are exposed from the first surface and the second surface of the first plate respectively. The metal ball is assembled to the second through hole of the second plate, such that two ends of the metal ball are exposed from the first surface and the second surface of the second plate respectively.

According to a further aspect of the embodiment, a magnetic skidproof unit is provided at an upper end of the second surface of the first plate. The magnetic skidproof is adapted for obtaining an improved skidproof performance when the first plate is attached to a wall, and enhancing the magnetic attracting force of the first plate.

According to a further more aspect of the embodiment, the second surface of the first plate and the second surface of the second plate are configured to be coarse surfaces. Such coarse surfaces are optimal to be contacted and operated by user's fingers, and won't be slippery.

According to a still further aspect of the embodiment, the second through hole is configured with a cone shape having a small diameter end and a large diameter end. The small diameter end of the second through hole has a real round shaped cross-section and has a diameter slightly smaller than a diameter of the metal ball. A plurality of blocking members are provided on an inner surface of the second through hole. When the metal ball is put in the second through hole, the blocking members temporarily position and hold the metal ball for a while, during which a suitable gap is maintained between the metal ball and the inner surface of the second through hole and a binder agent is filled in the gap. Then, the metal ball is completely fitted in the second through hole and is tightly adhered to the small diameter end. In such a way, the metal ball can be assembled with the second through hole.

Further, the metal ball is adapted for attracting and being attracted by the magnet. The metal ball can be a steel ball, or a ball member made of other metal material. In such a way, when the magnet and the metal ball are attracted each other, the metal ball obtains magnetism, and everywhere of the metal ball functions as a magnet capable of attracting small metal objects.

### BRIEF DESCRIPTION OF THE DRAWINGS

The present invention will be apparent to those skilled in the art by reading the following detailed description of preferred embodiments thereof, with reference to the attached drawings, in which:

FIG. 1 is an exploded perspective view of a magnetic clip according to an embodiment of the present invention;

FIG. 2 is a perspective view of the magnetic clip of the present invention;

FIG. 3 illustrates the magnetic clip of the present invention being attached on a wall, attracting a metal object and clamping a paper;

FIG. 4 is a partial cross-sectional view of the assembly structure of the second plate and the metal ball of the magnetic clip of the present invention;

FIG. 4A illustrates the metal ball being temporarily preliminarily held in the second through hole by the blocking members;

FIG. 4B illustrates the metal ball being completely fitted in the second through hole; and

FIG. 5 is a partial cross-sectional view of the assembly structure of the first plate and the magnet.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

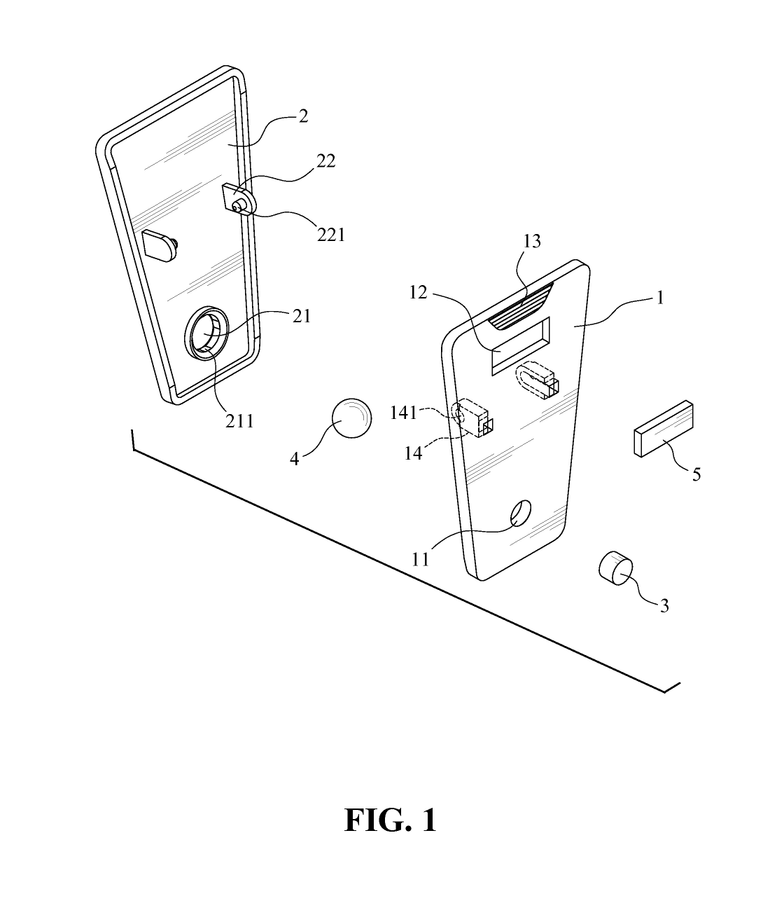

FIG. 1 is an exploded perspective view of a magnetic clip according to an embodiment of the present invention. Referring to FIG. 1, the present invention provides a magnetic clip including a first plate 1 and a second plate 2.

The first plate 1 has a first surface and a second surface. The first plate 1 includes a first pair of protrusion ears 14 integrally formed together with the first plate 1. The first pair of protrusion ears 14 are configured with axially corresponded co-linear pivotal holes 141 respectively. The first plate 1 is configured with a first through hole 11 at a bottom end of the first plate 1. A magnet 3 is secured inside the first through hole 11. The magnet 3 has two ends exposed from the first surface and the second surface of the first plate 1, respectively. Preferably, the magnet 3 is a powerful magnet.

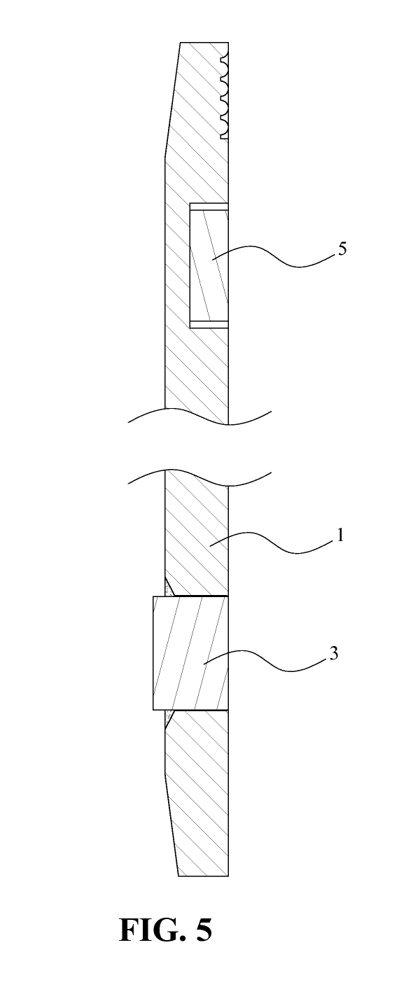

FIG. 5 is a partial cross-sectional view of the assembly structure of the first plate and the magnet. Referring to FIG. 5, preferably, the magnet 3 is secured in the first through hole 11 of the first plate 1 as following. At first, the magnet 3 is inserted into the first through hole 11. Then, a binder agent is provided from a slope configured at a periphery of the first through hole 11 toward the first through hole 11. After the binder agent is cured, the magnet 3 is then secured inside the first through hole 11 of the first plate 1. The second surface of the first plate 1 is configured with a coarse surface 13 at an upper end of the first plate 1, and a recess 12 configured beneath the coarse surface 13. A magnetic skidproof unit 5 is received inside the recess 12. The magnetic skidproof unit 5 is a ferrogum which serves as a cushion capable of magnetically attracting and skidproofing. The magnetic skidproof unit 5 can be used to facilitate the first plate 1 to be more stably attached to a magnetic wall with a skidproof function.

The second plate 2 has a first surface and a second surface. The second plate 2 includes a second pair of protrusion ears 22. The second pair of protrusion ears 22 are configured with axially corresponded co-linear pivotal shafts 221. The second plate 2 is configured with a second through hole 21 at a bottom end of the second plate 2. A metal ball 4 is secured inside the second through hole 21. The metal ball 4 has two ends exposed from the first surface and the second surface of the second plate 2. Preferably, in the current embodiment, the metal ball is a steel ball. In other embodiments, the metal ball 4 can also be made of other metal materials.

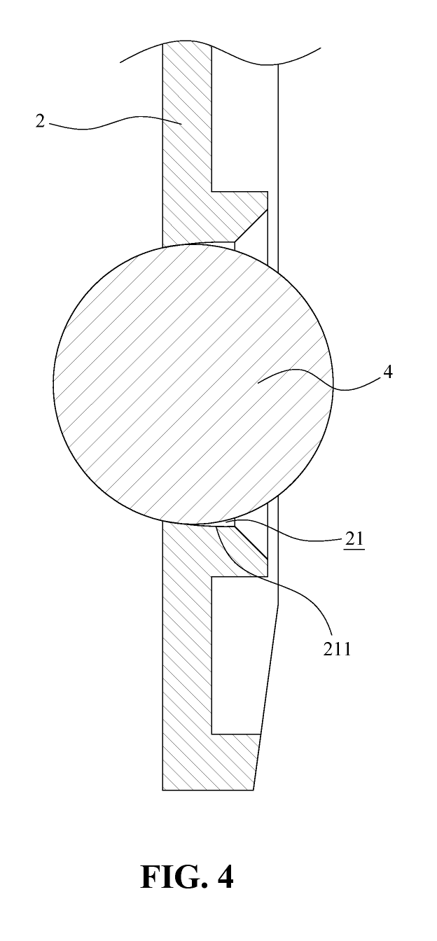

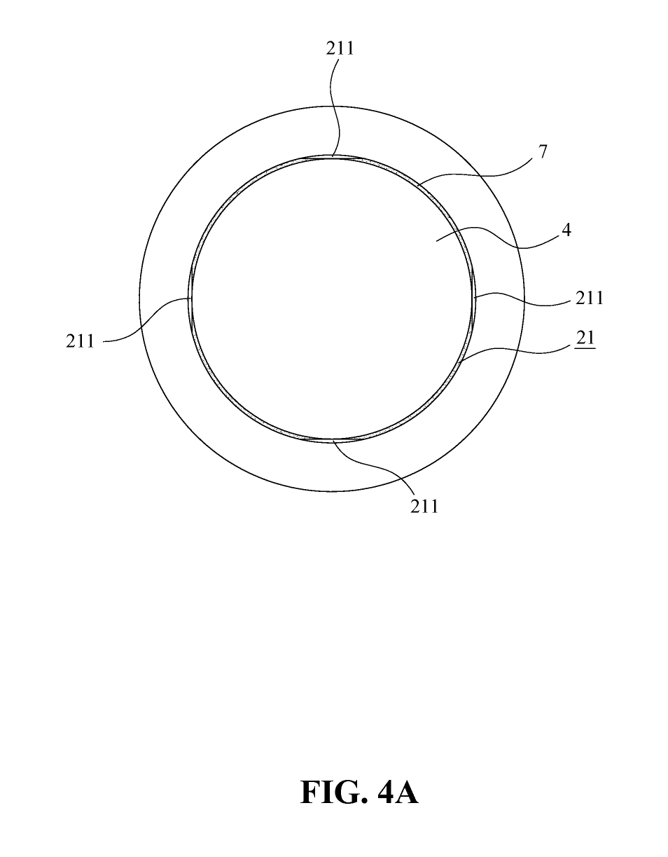

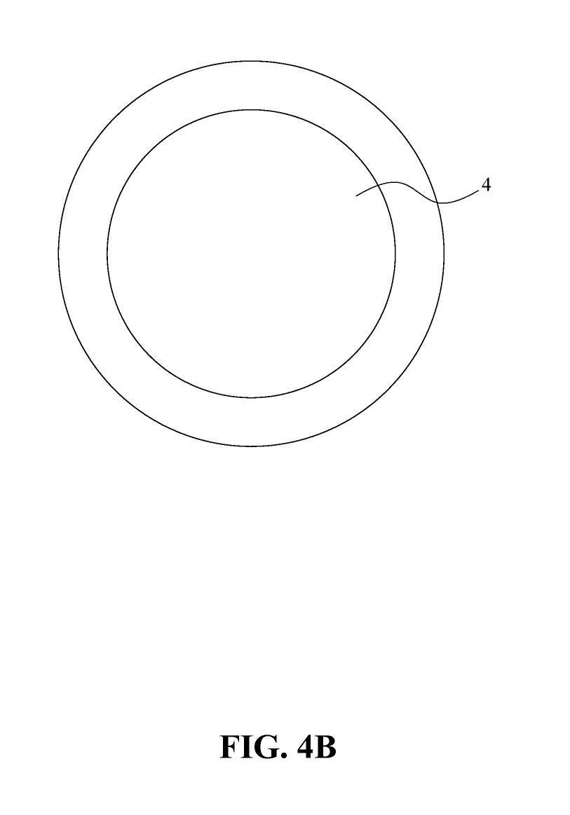

FIG. 4 is a partial cross-sectional view of the assembly structure of the second plate and the metal ball of the magnetic clip of the present invention. FIG. 4A illustrates the metal ball being temporarily preliminarily held in the second through hole by the blocking members. FIG. 4B illustrates the metal ball being completely fitted in the second through hole. Referring to FIGS. 4 and 4A, the second through hole 21 is configured with a cone shape having a small diameter end and a large diameter end. The small diameter end of the second through hole 21 has a real round shaped cross-section and has an inner diameter slightly smaller than a diameter of the metal ball 4. A plurality of blocking members 211 are provided on an inner surface of the second through hole 21. The blocking members 211 are flat members extending from the large diameter end toward the small diameter end. The blocking members 211 together define an inner diameter slightly smaller than the inner diameter of the small diameter end of the second through hole 21. When the metal ball 4 is put in the second through hole 21, the blocking members 211 temporarily position and hold the metal ball 4 for preventing the metal ball 4 dropping off from the second through hole 21, during which a suitable gap is maintained between the metal ball 4 and the inner surface of the second through hole 21 and a binder agent 7 is filled in the gap. Then, the metal ball 4 is completely fitted in the second through hole 21 and is tightly adhered to the small diameter end of the second through hole 21 as shown in FIG. 4B. In such a way, the metal ball 4 can be assembled with the second through hole 21.

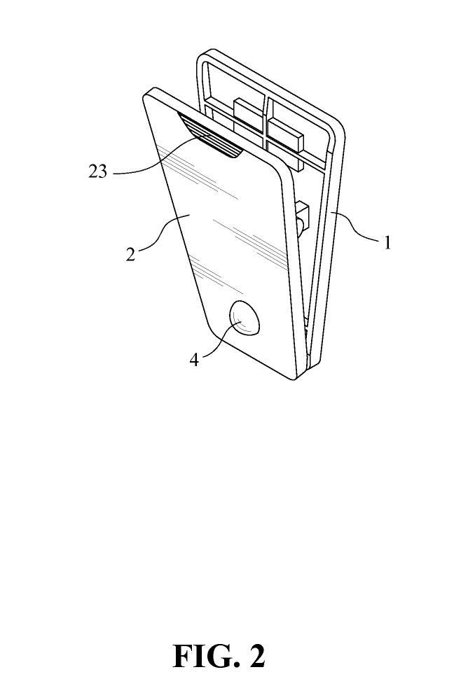

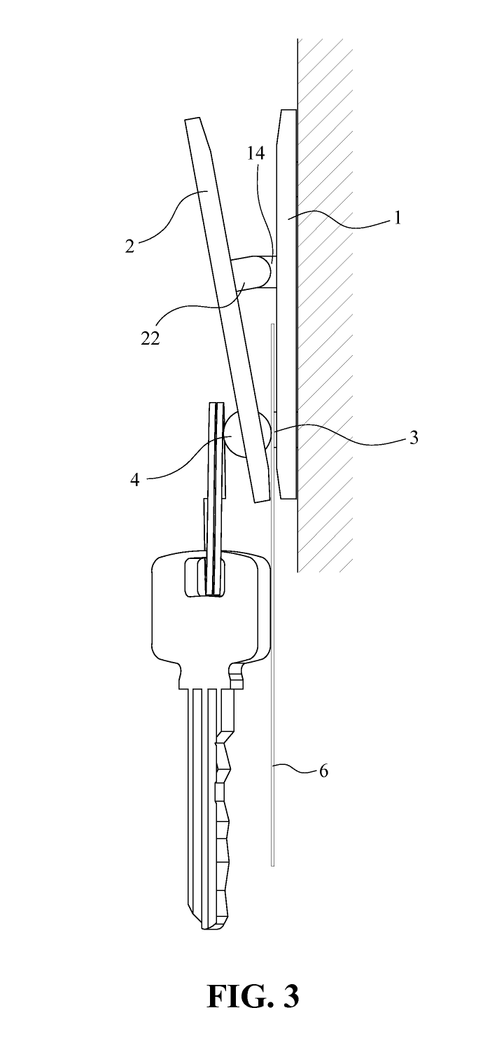

FIG. 2 is a perspective view of the magnetic clip of the present invention. FIG. 3 illustrates the magnetic clip of the present invention being attached on a wall, attracting a metal object and clamping a paper. Referring to FIGS. 2 and 3, the first plate 1 and the second plate 2 are pivotally coupled together by coupling the pivotal holes 141 with the pivotal shafts 221, such that the first surface of the first plate 1 and the first surface of the second plate 2 are oppositely positioned, and the first plate 1 and the second plate 2 are allowed to swing relative to each other. Accordingly, the magnet 3 and the metal ball 4 are correspondingly positioned, so that when the magnet 3 approaches to the metal ball 4, they are attracted each other.

Referring to FIG. 3, in operation, the first plate 1 is placed against a wall which can be magnetically attracted, such as an iron plate or steel plate. The magnet 3 is magnetically attached to the wall. Facilitated by the magnetic skidproof unit 5, the first plate 1 can be more stably secured on the wall. The magnetic clip can be opened by applying a force on the upper end of the second plate 2. When a user applies a force on the upper end of the second plate 2, in accordance with the lever principle, the magnetic attracting force between the magnet 3 and the metal ball 4 is overcome to separate the bottom ends of the first plate 1 and the second plate 2. In this case, a note paper 6 (or any other paper) can be inserted between separated bottom ends of the first plate 1 and the second plate 2. When the force applied on the upper end of the second plate 2 is released, the magnetic attracting force between the magnet 3 and the metal ball 4 returns the bottom end of the second plate 2 back, so as to clamp the note paper 6 between the magnet 3 and the metal ball 4.

In summary, the present invention employs a magnet 3 and a metal ball 4. When the magnet 3 approaches to the metal ball 4, the metal ball 4 is magnetized, and becomes another ball-shaped magnet. In such a way, everywhere of the metal ball 4 presents a magnetic characteristic and can be used to magnetically secure small metal objects. Therefore, small metal objects such as a key ring, paper clips, or drawing pins can be directly put on the metal ball 4 without opening the first plate 1 and the second plate 2. To take off the small metal objects, only a small force is required to overcome the magnetic attracting force between the small metal objects and the metal ball 4.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A magnetic clip, comprising:
a first plate having a first surface and a second surface; and
a second plate having a first surface and a second surface, wherein the first plate and the second plate are pivotally coupled together, wherein the first surface of the first plate is positioned opposite to the first surface of the second plate;
a magnet provided at the first surface of the first plate; and
a metal ball, being provided at the second plate and positionally corresponding to the magnet.

2. The magnetic clip as claimed in claim 1, wherein the metal ball is a steel ball.

3. The magnetic clip as claimed in claim 1, further comprising a magnetic skidproof unit provided at the second surface of the first plate.

4. The magnetic clip as claimed in claim 1, wherein the second surface of the first plate and the second surface of the second plate are respectively configured with coarse surfaces adapted for being contacted with and operated by fingers of a user.

5. The magnetic clip as claimed in claim 1, wherein the first plate is configured with a first through hole, and the second plate is configured with a second through hole, wherein the magnet is assembled in the first through hole and the metal ball is assembled in the second through hole.

6. The magnetic clip as claimed in claim 1, wherein the first plate comprises a first pair of protrusion ears configured at the first surface of the first plate, and the second plate comprises a second pair of protrusion ears configured at the second surface of the second plate, wherein the first pair of protrusion ears are configured with axially corresponded co-linear pivotal holes respectively, and the second pair of protrusion ears are configured with axially corresponded co-linear pivotal shafts, wherein the first plate is pivotally coupled with the second plate by coupling the pivotal holes with the pivotal shafts.

7. The magnetic clip as claimed in claim 1, wherein the magnet has two ends exposed from the first surface and the second surface of the first plate.

8. The magnetic clip as claimed in claim 1, wherein the metal ball has two ends exposed from the first surface and the second surface of the second plate.

9. The magnetic clip as claimed in claim 5, wherein the second plate comprises a plurality of blocking members disposed inside the second through hole, and the blocking members define an inner diameter smaller than an inner diameter of the second through hole.

10. The magnetic clip as claimed in claim 9, wherein the blocking members are flat members longitudinally extending for a certain length.
